(19) United States
(12) Patent Application Publication
(10) Pub. No.: US 2025/0139648 A1
(43) Pub. Date: May 1, 2025

(54) DYNAMIC MINIMUM PRESENTATION FOR OPTIMIZED FRESH ITEM PRODUCTION

(71) Applicant: Walmart Apollo, LLC, Bentonville, AR (US)

(72) Inventors: Jiahao Zhang, Frisco, TX (US); Raisa Mukadam, Carrollton, TX (US); Karun Dhingra, Rogers, AR (US)

(21) Appl. No.: 18/498,624

(22) Filed: Oct. 31, 2023

(51) Int. Cl. G06Q 30/0202; G06Q 10/087; G06Q 30/0201

(52) U.S. Cl. CPC G06Q 30/0202; G06Q 10/087; G06Q 30/0206

(57) ABSTRACT

Examples provide for generating dynamic minimum presentation (MP) values for optimizing fresh item production while reducing system resource usage. An MP engine calculates a monetary level impact of overproduction and underproduction of a fresh item using production-related data, including a shelf life of the fresh item and cost of production. The calculated monetary level impact includes predicted monetary loss from lost sales due to an item going out-of-stock and/or monetary loss from unsold instances of the fresh item where too many instances of the fresh item are prepared. The dynamic MP value is generated based on dynamic data, the item attribute data, and the predicted monetary loss. The dynamic MP value is used to create a production plan recommendation customized at a store-item level for a selected date, thereby enabling optimization of safety stock while minimizing system resource usage consumed in generating MP predictions for fresh items.

### BACKGROUND

Many retail facilities provide fresh items for purchase which have relatively short shelf-life, such as, but not limited to, fresh bread from a bakery, fresh ground beef from a meat department and/or fresh cooked chicken from a deli department. It is typically necessary to produce these fresh items on-site each day to maximize freshness for customers. However, it is difficult to predict how many fresh items to produce each day because demand varies from day-to-day. Production occurs before the actual demand for any given day can be known. If too many fresh items are produced, some of them may not sell on the day they are produced. Fresh items remaining until the next day may lose some of their freshness, making them less desirable. This is referred to as overproduction. Likewise, if too few fresh items are produced for a given day, this may result in an item going out-of-stock. This is referred to as underproduction. Currently, most systems use rules-based systems to predict the number of fresh items to be produced for each day. However, this frequently results in inaccurate predictions causing lost revenue due to both lost sales due to unavailability of fresh items when underproduction occurs and increased costs due to item throws resulting from overproduction. This is a sub-optimal system potentially causing customer dissatisfaction due to item outs, lost customers, decreased revenue, increased waste, and inefficient usage of resources.

### SUMMARY

Some examples provide a system for fresh item dynamic minimum presentation (MP) prediction using dollar cost metrics. The system includes a data storage device comprising historical production-related data for fresh items and item attribute data associated with each item in a plurality of fresh items. A production plan (PP) manager obtains a demand probability distribution for a fresh item associated with a selected retail location. The PP manager identifies a predicted demand for the fresh item on a selected date using the demand probability distribution. A monetary level impact of overproduction and underproduction of the fresh item is calculated using the item attribute data. The item attribute data includes a shelf life of the fresh item and a production cost per each instance of the fresh item. The calculated monetary level impact includes predicted monetary loss from a lost sale due to underproduction and predicted monetary loss from an unsold instance of an already produced fresh item due to overproduction. The PP manager generates a dynamic MP value customized at a store-item level for the selected date using dynamic data associated with the retail location and the selected date, the item attribute data, and the predicted monetary loss. The dynamic MP value includes a recommended number of instances of the fresh item to be produced at the retail location in excess of the predicted demand for the fresh item on the selected date. The dynamic MP value optimizes safety stock while minimizing system memory resource usage by relying on dynamic data rather than using a less-accurate, memory-intensive rules-based engine.

Other examples provide a method for fresh item dynamic MP prediction using dollar cost metrics. A monetary level impact of overproduction for a fresh item and the monetary level impact of underproduction of the fresh item is calculated using item attribute data for the fresh item. The item attribute data includes shelf life of the fresh item and production cost per instance of the item. The monetary level impact includes predicted monetary loss from a lost sale and predicted monetary loss from an unsold instance of the fresh item. The PP manager generates a dynamic minimum presentation (MP) value customized at an item level using the item attribute data, the calculated monetary level impact of overproduction and underproduction and historical production-related data associated with the fresh item at a selected retail location. The dynamic MP value includes a recommended number of instances of the fresh item to be produced at the retail location in excess of the predicted demand for the fresh item on a selected date. The PP manager creates a production plan recommendation including the dynamic MP value. The production plan recommendation is presented to a user or other recipient via a user interface device.

Still other examples provide one or more computer storage devices having computer-executable instructions stored thereon, which, upon execution by a computer, cause the computer to perform operations including generating a demand probability distribution for a fresh item associated with a selected retail location using production-related data and item attribute data for the fresh item. A predicted demand for the fresh item on a selected date is identified using the generated demand probability distribution and the historical production-related data. A monetary level impact of overproduction of the fresh item and underproduction of the fresh item is calculated using the item attribute data. The calculated monetary level impact includes predicted monetary loss from lost sales and predicted monetary loss from unsold instances of the fresh item. A dynamic minimum presentation (MP) value for the selected date is generated using dynamic data associated with the retail location and the selected date, the item attribute data, and the predicted monetary loss. The dynamic MP value optimizes safety stock while minimizing monetary losses associated with overproduction and underproduction of the fresh item.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for dynamic minimum presentation (MP) optimizing fresh item production.

FIG. 2 is an exemplary block diagram illustrating a system for calculating a dynamic minimum presentation value on an item-store-date level.

FIG. 3 is an exemplary block diagram illustrating a retail location associated with fresh items with safety stock based on minimum presentation values calculated at an item-store level.

FIG. 4 is an exemplary block diagram illustrating a data storage device storing data used in calculating dynamic minimum presentation values.

FIG. 5 is an exemplary block diagram illustrating a production plan (PP) manager for generating dynamic minimum presentation values.

FIG. 6 is an exemplary flow chart illustrating operation of the computing device to dynamically update a production plan recommendation based on real-time inventory updates.

FIG. 7 is an exemplary flow chart illustrating operation of the computing device to generate a dynamic minimum presentation value using item attribute data and monetary loss function.

FIG. 8 is an exemplary flow chart illustrating operation of the computing device to generate a dynamic production plan recommendation.

FIG. 9 is an exemplary table showing input data for generating dynamic MP value.

FIG. 10 is an exemplary bar graph representing a probability distribution for a fresh item.

FIG. 11 is an exemplary table representing calculated values where three instances of a fresh item are produced.

FIG. 12 is an exemplary table representing calculated values where four instances of the fresh item are produced.

FIG. 13 is an exemplary table representing exemplary input and output associated with the production plan manager.

FIG. 14 is an exemplary table representing exemplary output produced by the production plan manager.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . .” For brevity and clarity of presentation, this implied leading clause is not repeated ad nauseum.

In the production of fresh items at a retail store or other retail environment, the minimum presentation (MP) refers to the quantity of items that is desirable to have remaining at the end of the day for carry-over to the following day. Currently, rule-based systems are used to generate daily demand and MP forecasts per fresh item. Safety stock refers to the instances (units) of a fresh item which are produced in excess of expected demand for carryover to the next day. Carryover refers to items which fail to sell on the day the item is prepared or obtained. These items carry over for possible sale the next day. The safety stock helps prevent the fresh item from going out of stock if demand on a given day is greater than expected. The safety stock further provides an inventory of fresh items at the beginning of the day before personnel have time to produce or prepare additional instances of the fresh item.

The term production, as used herein refers to obtaining, baking, cooking, mixing, heating, decorating, or otherwise preparing a fresh item for sale. Producing a fresh item includes, for example, baking a cake, cookies, bread, or other baking other items typically sold in a bakery or bakery department. Producing a fresh item also includes decorating a pre-baked cake, cookies, cupcakes, or other pre-baked items with icing, fruit, whipped topping, or other decorations and toppings. Producing a fresh item in other examples includes cooking such as roasting, frying, warming, heating, baking, rotisserie cooking, or any other preparation of ready-to-eat items. Producing fresh items can also include slicing cheeses, fruit, vegetables, meats, breads, or other items for sale. Thus, the term item production includes any type of preparation of fresh items for sale on a regular basis to maximize freshness of the item, such as producing fresh bread daily.

When the forecast is accurate, a retail location should have roughly the MP number of instances of the fresh item remaining at the end of the day, which can be carried over to the next day. The MP allows the system to control the number of fresh items prepared in excess of expected demand, ensuring that the retail location can maintain a safety stock for fresh items that have a short shelf life and fulfill customer demand.

Existing solutions rely heavily on manual input from human users to provide operational experience and business insights to determine how many instances of fresh items should be prepared or obtained each day using historical data and static rules. This is labor intensive and frequently inaccurate leading to overproduction as well as underproduction of fresh items. Likewise, this manual and rules-based process frequently leads to erroneous predictions and inaccurate calculations of expected demand and desired minimum presentation quantities of fresh items to be prepared and/or obtained for sale each day at a retail facility.

In other solutions, a heuristic logic dominates the daily minimum presentation recommendation, which leads to inaccurate fresh item demand estimates. The inaccurate demand estimates result in stocking too many fresh items. This overproduction results in extra throws/donations, causing unnecessary waste and increasing costs associated with fresh items.

The rules and hardcoded penalties utilized by existing systems require large amounts of system memory usage, increasing time and expenses associated with managing safety stock. Moreover, these rules-based system frequently fail to account for actual financial impact of overproduction and underproduction, where reduced freshness of carry-overs is not quantified, operational risk is not included in risk assessments, and business constraints override optimal machine learning driven results. This presents a challenge for accurate and/or optimal minimum presentation of fresh items while consuming system resources associated with memory and processing. Boosting sales is one of the goals of fresh item production plans, balancing the potential loss of sales and waste from overproduction while reducing resource usage is another advantage.

Moreover, storing sufficient quantities of historical data associated with fresh item production plans and numerous static rules associated with the rules-based systems for predicting daily safety stock requirements frequently consumes large amounts of memory resources for constantly changing rules as input from human users associated with inaccurate predictions. This is an expensive and inefficient process.

These problems are solved, in some examples, by providing a production plan (PP) manager that generates a more accurate dynamic MP using a machine learning (ML) and monetary level impact rather than relying on static rules. In this manner, the system reduces memory usage which would otherwise be consumed by storing large quantities of static rules and other static data.

Some examples of the disclosure enable dynamically generated MP recommendations customized at an item and store level. The production plan manager calculates a monetary level impact of overproduction of the fresh item and underproduction of the fresh item using the item attribute data based on shelf life of the fresh item and a production cost per each instance of the fresh item. The calculated monetary level impact includes predicted monetary loss from a lost sale of the fresh item as a result of underproduction and a predicted monetary loss from an unsold instance of the fresh item as a result of overproduction of the fresh item. This enables the system to more accurately balance the monetary costs of overproduction and underproduction when calculating an optimal MP number of instances of the fresh item for safety stock to avoid unavailability of an item (item outs) while minimizing item throws. An item throw is an item that fails to sell prior to expiration of the sell-by-date necessitating disposal of the item.

Other examples provide a dynamic MP value customized at a store-item level for a specific date using dynamic data associated with the retail location and the selected date, item attribute data and the predicted monetary loss. The system balances costs associated with overproduction and underproduction to maximize fresh item availability to customers while minimizing monetary losses associated with overproduction and underproduction of the fresh item.

The computing device operates in an unconventional manner by utilizing ML and dynamic data to calculate a more accurate and reliable dynamic MP value for managing safety of a selected item in a selected retail store on a selected date instead of relying on a static rules-based engine, thereby reducing system resource usage, such as the memory and processor resources, expended in generating daily fresh item production plans. The system expends fewer resources calculating daily demand and avoids the necessity of re-calculate inaccurate predicted demands to optimize safety stock numbers for each fresh item thereby reducing processor usage. The system further reduces memory usage by eliminating usage of static rules for calculating MP.

In other examples, the system dynamically updates the MP values in real-time as updated inventory data is available throughout the day. In this manner, the system can provide updated production recommendations to users to prevent item outs and overproduction from occurring. This further reduces error rates in predicted demand and predicted MP values for fresh items.

In still other examples, the system outputs a recommended MP value to a user via a user interface device. This enables the user to easily view recommended numbers of fresh items to produce each day based on dynamic data, such as current events, seasonal changes, weather conditions, etc. The system generates MP values and updated MP values dynamically, thereby improving user efficiency via the UI interaction and increasing user interaction performance.

Other examples reduce memory resource usage and network bandwidth usage by calculating daily expected demand and minimum presentation values using dynamic data rather than static rules. This reduces memory and other data storage resources which would otherwise be consumed storing the rules utilized by the rules-based engine while reducing network bandwidth usage consumed in updating the rules. In this manner, system resource usage is reduced while optimizing daily production planning for fresh items. The dynamic MP value further enables creation of adequate safety stock for the fresh item while minimizing resource usage.

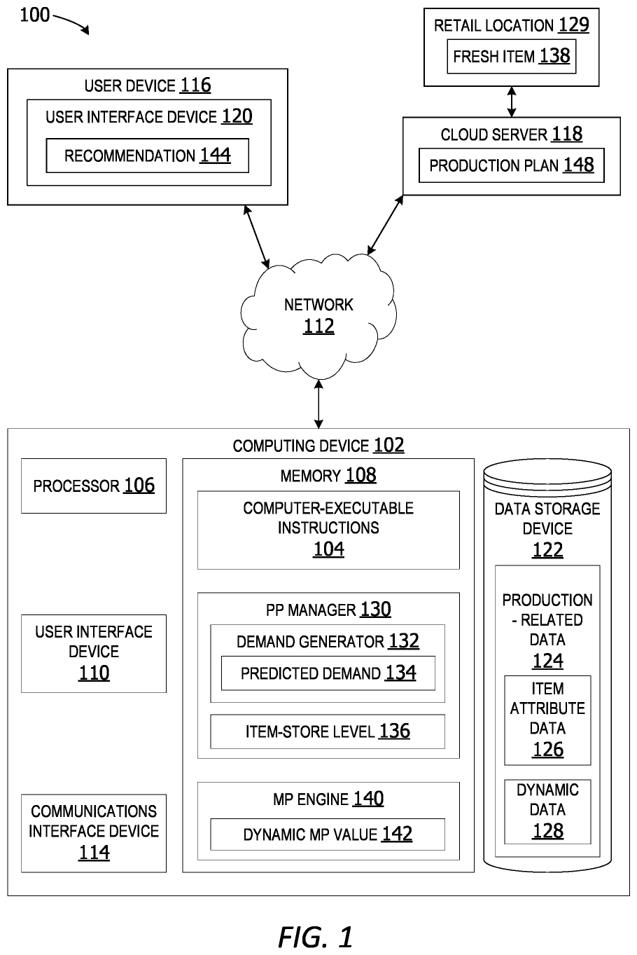

Referring again to FIG. 1, an exemplary block diagram illustrates a system 100 for dynamic minimum presentation optimizing fresh item production. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

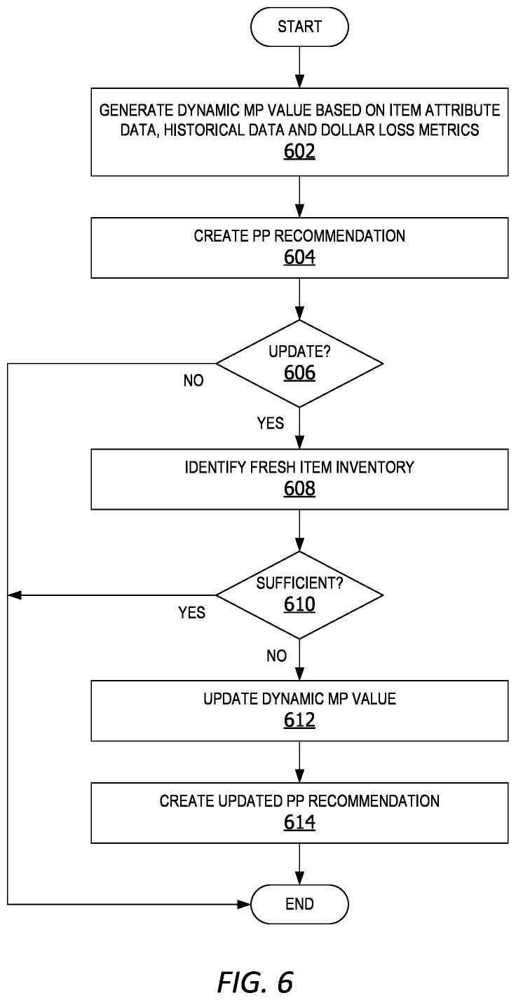

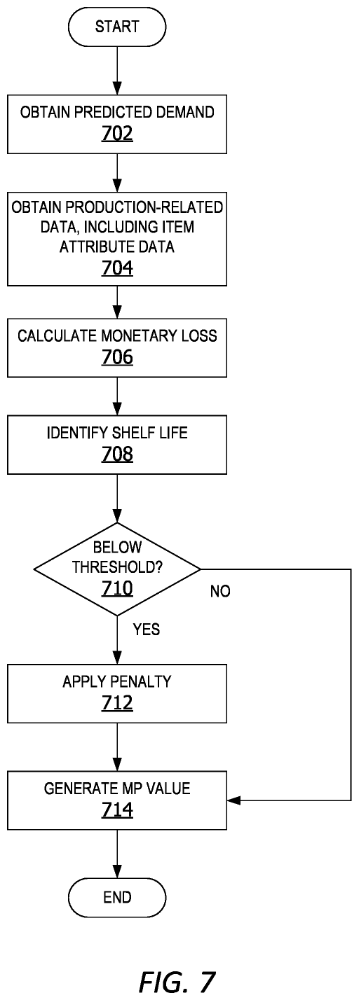

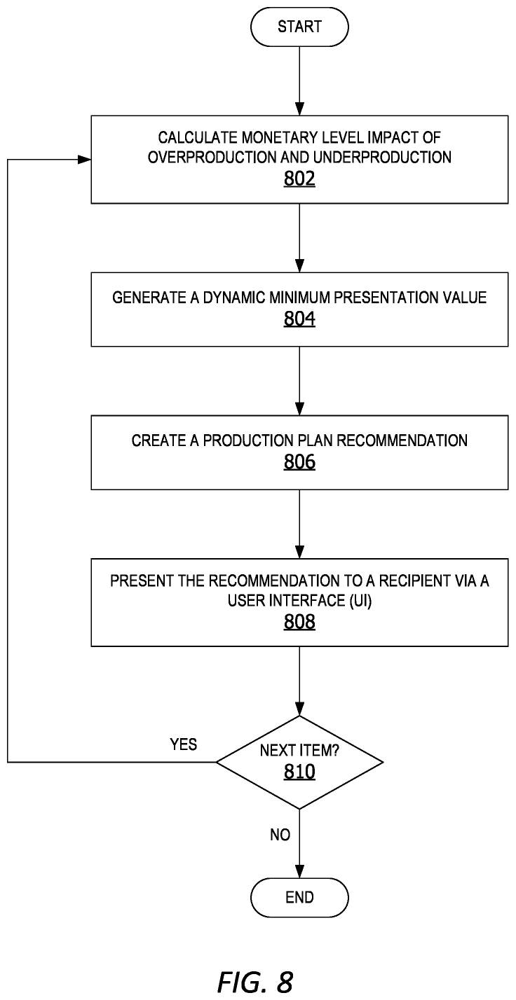

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 6, FIG. 7, and FIG. 8).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device 120.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data areas. In other examples, the cloud server 118 is associated with a distributed network of servers.

The system 100 can optionally include a data storage device 122 for storing data, such as, but not limited to production-related data 124, including the item attribute data 126 and/or dynamic data 128. The production-related data 124 is data associated with production of fresh items at one or more retail facilities, such as the retail location 129. Production-related data includes data associated with MP and demand for a fresh item at a given location on a given date, such as, but not limited to, item attribution data (item attributes), historical data, and dynamic data. The historical data includes historical fresh item sales data, historical production plans for fresh items, historical minimum presentation for fresh items, etc. In this example, the production-related data is data associated with the retail location 129. In other examples, the production-related data 124 includes data associated with the retail location and one or more other retail facilities in locations or regions which are similar to the retail location 129.

The retail location 129, in this example, is a brick-and-mortar retail location supplying a plurality of items for purchase by customers. In this non-limiting example, the retail location 129 is a grocery store or a store having a grocery department providing fresh items for purchase.

A fresh item is a perishable item that has a relatively short shelf life which are produced or prepared on a regular basis to maximize freshness of the item, such as items that are prepared daily for sale on the day it is prepared or on the following day. However, the examples are not limited to items that are sold within one or two days. In other examples, a fresh item has a shelf life of a week or less.

A fresh item is an item produced on premises at the retail location 129 for sale within a relatively short period of time, such as, but not limited to, a week or less. Thus, a fresh item may have a shelf life of one day, a shelf life of two days, a shelf life of three days, a shelf life of four days, a shelf life of five days, etc. However, an item is not considered a fresh item if it has a shelf life of more than a week in these examples. Thus, it is not practical to ship the fresh items from another location in most situations. Therefore, the fresh items are items having a relatively short shelf life which are produced and/or prepared each day for sale within the relatively short shelf life of the item. In some examples, a fresh item has a shelf life of one or two days from the time the item is ready for sale. Fresh items include bread, fried chicken, roasted chicken, salads, freshly ground beef, pies, cakes, cookies, etc. Fresh items are items located in a deli department, bakery department, meat department, produce and other departments offering fresh items for sale. Fresh items frequently lose “freshness” on the day following production. For example, bread baked on Monday is considered “day old bread” the next day on Tuesday, reducing the desirability of the bread even if the shelf life of the bread has not yet expired. Thus, there is a tension between maintaining adequate safety stock for carryover while minimizing the number of unsold instances of fresh items failing to sell on the day the items are produced due to reduced freshness associated with the fresh items each day the fresh item fails to sell after initial preparation of the item.

Item attribute data 126 is data describing attributes of a fresh item. The item attribute data 126 includes data, such as, but not limited to, an item identifier (ID), item purchase price (sale prices), item size, variety, item weight, ingredients, cost to produce one instance of the item (unit cost), and/or shelf life.

Dynamic data 128 is data associated with a location or area associated with the retail location 129. Dynamic data 128 includes data such as, but not limited to, weather-related data, local events, seasonal events, inventory data, transaction data, etc. Inventory data describes the number of instances of each item currently available for purchase by customers within the retail facility.

The data storage device 122 can include one or more different types of data storage devices, such as, for example, one or more rotating disks drives, one or more solid state drives (SSDs), and/or any other type of data storage device. The data storage device 122 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 122 includes a database.

The data storage device 122 in this example is included within the computing device 102, attached to the computing device, plugged into the computing device, or otherwise associated with the computing device 102. In other examples, the data storage device 122 includes a remote data storage accessed by the computing device via the network 112, such as a remote data storage device, a data storage in a remote data center, or a cloud storage.

In this example, the production-related data 124, item attribute data 126 and dynamic data 128 are located in the data storage device 122 associated with the computing device 102. In other examples, the production-related data 124, item attribute data 126 and/or the dynamic data 128 are stored, in whole or in part, on one or more of a cloud storage, a remote data store device or other data store accessed by the computing device 102 via the network 112.

The production-related data 124 includes data associated with previous amounts of fresh items prepared and/or produced for a previous day. In other words, the production-related data 124 includes historical data identifying actual numbers of fresh item instances in stock on previous days. The actual numbers of fresh items produced and/or prepared on a previous day may be different than the recommended numbers of items for predicted demand and/or minimum presentation. The discrepancies between the recommended production (predicted demand and minimum presentation) and actual number of fresh items made available on a given day may occur due to shortages in ingredients available on a given day, a staffing shortage preventing preparation of the recommended number of items, human error, or mistake, etc. Thus, the production-related data 124 in some examples includes date, fresh item ID, number of instances of the fresh item produced on the date, etc.

The memory 108 in some examples stores one or more computer-executable components, such as, but not limited to, the production plan (PP) manager 130. The PP manager 130 is a hardware, firmware, and/or software component configured to generate a daily production recommendation 144 customized at a store-item level for a specific data based on a dynamic MP value and predicted demand. In some examples, the recommendation 144 is presented to a user via a user interface, such as, but not limited to, the user interface device 110 and/or the user interface device 120. The recommendations for the plurality of fresh items are used to create a production plan 148 customized for the retail facility (store) for a specific date. The production plan 148 includes the recommended number of instances of each fresh item in a plurality of fresh items within one or more departments of the retail facility. In some examples, the production plan 148 includes the daily recommended number of instances of all fresh items to be produced on a selected day for all departments in the retail facility.

In some examples, the PP manager 130 includes a demand generator 132 that generates a predicted demand 134 for a fresh item 138 at the retail location 129 on a selected date and/or selected time-period using a machine learning (ML) probabilistic distribution model. The predicted demand 134 is generated using the production-related data 124, including the item attribute data 126 and the dynamic data 128 which influence changing daily demand for the fresh item. In other examples, the PP manager does not include the demand generator 132. Instead, the PP manager 130 obtains the predicted demand 134 from a demand generator hosted on the cloud server 118 and/or the user device 116. In these examples, the PP manager 130 sends a request for a current predicted demand for a given fresh item to the demand generator on the cloud server. The cloud server generates the predicted demand and transmits it to the PP manager in response.

In other examples, the PP manager pulls the predicted demand from a data store, such as the data storage device 122 or a remote data store, such as a cloud storage or other remote data storage device. In still other examples, the PP manager obtains a demand probability distribution associated with the fresh item 138 from a demand generator located on the cloud server 118 and/or another remote computing device, such as the user device 116. The PP manager uses the demand probability distribution received via the network to identify the predicted demand 134 having the highest probability at an item-store level.

The PP manager 130 in this example, includes a minimum presentation (MP) engine 140. However, the examples are not limited to the PP manager 130 including the MP engine 140. In other examples, the MP engine 140 is implemented separately from the PP manager 130. In these examples, the MP engine can be implemented as a separate component on the same computing device. In other examples, the MP engine is implemented on a different computing device than the PP manager 130. In these examples, a first computing device hosting the PP manager 130 is communicatively coupled to the second computing device hosting the MP engine 140.

The MP engine 140 is a machine learning/deep learning model. The MP engine 140 calculates a monetary level impact of overproduction and underproduction of the fresh item using the item attribute data 126 using a unique loss function which translates unit losses for overproduction and underproduction into monetary dollar loss. The MP engine 140 balances fresh item shelf life with monetary losses to identify an optimized safety stock which minimizes potential monetary losses due to both overproduction and underproduction. The MP engine is trained using labeled training data and historical production data for fresh item inventory associated with one or more brick-and-mortar retail facilities.

The item attribute data 126 includes a shelf life of the fresh item, a production cost per each instance of the fresh item, and/or other data associated with the item attribute data 126. The calculated monetary level impact includes the predicted monetary loss occurring from a lost sale of the fresh item 138 occurring where a fresh item is out-of-stock and the predicted monetary loss from a throw due to an unsold instance of the fresh item 138. An unsold instance of the fresh item is an unwanted or unsold item that eventually is disposed of due to the fresh item approaching its maximum shelf life. An unsold instance of the fresh item in other examples includes items placed on clearance or discount prior to expiration of the shelf life of the item. This enables the item to be sold at cost or potentially at a loss prior to expiration of the shelf life of the item.

The predicted monetary loss includes additional factors beyond the price of the item sold or the cost of the ingredients used to prepare the fresh item. The monetary loss calculations include predicted monetary loss due to lost customer goodwill and monetary loss associated with lost memberships where fresh items are unavailable due to underproduction. The monetary loss calculations further include monetary loss due to human resources and time expended producing unwanted/unsold items and monetary losses associated with removal and disposal of excess instances of fresh items which go unsold due to overproduction, as well as other factors affecting revenues.

In other examples, the MP engine 140 generates a dynamic minimum presentation (MP) value 142 customized at an item-store level 136 for the selected date using dynamic data 128 associated with the retail location 129, the item attribute data 126, and the predicted monetary loss due to overproduction and underproduction of a fresh item on a given day. The dynamic MP value 142 is generated using dynamic data obtained in real-time to calculate the MP value rather than relying upon historical data and a set of static rules to calculate the MP value. The dynamic data includes data, such as current weather data, inventory data, etc. This dynamic data enables a more accurate MP value to be determined.

An updated dynamic MP value 142, in other examples is generated during the day after some production of the fresh item has already begun. For example, if production of the fresh item begins at six in the morning (6:00 a.m.) based on a first MP value generated the previous day, the system can utilize dynamic data associated with sales of instances of the fresh item, number of instances of the fresh item produced/prepared, and/or ingredients in inventory available for producing additional instances of the fresh item to generate the updated dynamic MP value at noon (12:00 p.m.). The updated dynamic MP value more accurately reflects demand on a given day than the initial MP value available in the morning. The updated dynamic MP value is generated in-real time to reflect demand more accurately on the day the MP value is generated.

The dynamic MP value 142 includes a recommended number of instances of the fresh item 138 to be prepared, procured, maintained, acquired, or otherwise produced at the retail location 129 in excess of the predicted demand 134 for the fresh item 138 on the selected date or date(s) at one or more production times within the given day. The recommended number of instances of the fresh item 138 is equal to the predicted demand plus the minimum presentation amount. The dynamic MP value 142 optimizes safety stock while minimizing monetary losses associated with overproduction and underproduction of the fresh item 138. Safety stock refers to excess instances of an item maintained in stock which exceeds expected demand.

The system 100, in some examples, dynamically generates MP values in real-time at an item-store-level each day enabling production areas at retail facilities to maximize fresh item safety stock each day while minimizing monetary losses for improved customer service and increased revenue due to fewer item outs (underproduction) and reduced item throws (overproduction).

In some examples, the system is built on historical tabular data sourced from various internal raw data sources. The granularity of the data can either be at the item level or the item/club level. The in-store sales history table provides a complete record of in-store sales for each item/club/date in a selected retail location (store). The item attributes' table provides comprehensive item attribute information, including details for fresh items such as shelf life. The fresh production plan table contains daily planning information for fresh items by associates, including carryover (the leftover quantity from yesterday). The financial report table provides information on dollar sales, dollar throws, and unit throws.

The probabilistic demand distribution, in some examples, is based on the forecast output from a probabilistic time series model. The samples (low number, ˜1 k) are converted into an approximate probability mass function (PMF). The system learns the distribution, then generates a lot of samples (˜1M) approximating the original model's distribution. The system rounds all these values to the nearest integer and counts the number of occurrences, turning the real-valued output into integers. From this empirical distribution, the system calculates the estimated probability of landing on each given value (e.g., 6242 times out of 1000000 being 81 is a 0.62% chance of 81 exactly).

In some examples, the production plan considers actual associate decision and feedback from a fresh application for each item-store. Based on machine learning intelligence recommendation, users determine how many instances of fresh items should be produced, along with the carryover from the previous day's minimum presentation. Meanwhile, the PP manager can adjust the production plan dynamically based on other signals, such as local events. This metric also reflects whether users follow PP recommendations by producing the recommended number of instances of the fresh items. Sometimes, even though users should be able to produce any forecast number from machine learning, inventory unavailability can occur, such as with an ingredient shortage. Inventory shortage could reduce users' ability to produce the recommended number of instances of the fresh Item.

Different fresh items have various shelf life limitations. Low shelf-life items are more likely to become waste when carried over, and reducing freshness might lead to customer dissatisfaction. For items having a long shelf-life, the probability of becoming waste is significantly lower than for items having a short shelf-life. The freshness penalty is non-linear, negatively related to shelf life, and contributes to ML loss when overproduction happens.

Instead of focusing on unit level loss (loss per item instance), the system translates unit deviation to dollar level impact. By including dollar cost, dollar sales, and dollar throws information, this changes the task of the optimization engine from balancing unit level under-forecast and over-forecast to balancing the dollar loss from lost sales and waste. This helps the ML solution optimize directly based on the (dollar cost metrics) metrics which the business is focusing on.

In other examples, the system includes a unique loss function that incorporates the principles of the newsvendor problem, which has always been a significant concern in inventory management. Traditional newsvendor models assume full knowledge of the demand probability distribution. However, in practice, characterizing the demand entirely can be difficult. Fresh's minimum presentation framework builds a risk-reward model based on the company's risk appetite for the newsvendor problem, considering probabilistic forecasts. This system includes a risk-tolerant strategy and establishes its competitive ratio to assist the “newsvendor” in selecting the optimal strategy based on their risk tolerance and probabilistic forecast.

In an example, a fresh item with a cost of making one unit as C, a retail price of one unit as S, demand as D, and forecast as θ. With an under-forecast, the lost sales equal to S*(D−θ). On the other hand, with an over-forecast, all carry-overs may end up becoming throws. The overproduction is equal to C*(θ−D). Under-forecasting can result in other losses, such as operational risk (σ), or membership loss (ϕ), so in this case, a higher penalty is imposed when under-forecasting. Over-forecasting, on the other hand, results in having too much carryover, which can lead to freshness reduction, particularly if the item has a shorter shelf life. Items with a higher shelf life tend to have more salvage value left. Hence, the system applies a shelf-life adjustment for different items (τ).

Based on these observations, the system includes a customized objective function using the newsvendor model to minimize the loss from both under-forecasting and over-forecasting. The system simulates probabilistic demand distribution using a deep learning algorithm.

$$optimized θ : argmin f ( θ ) = ( ( θ - D ) * C / τ \vert θ > D ) + ( ( D - θ ) * S + σ + ϕ \vert θ <= D )$$

In another example, an equation for optimized demand forecast is as follows:

$$optimizedMinPres = optimized θ - Mean ( θ )$$

The optimizedMinPres equation is applied for determining dynamic minimum presentation for optimizing fresh item production. The dynamic MP value enables creation of adequate safety stock for the fresh item while minimizing resource usage.

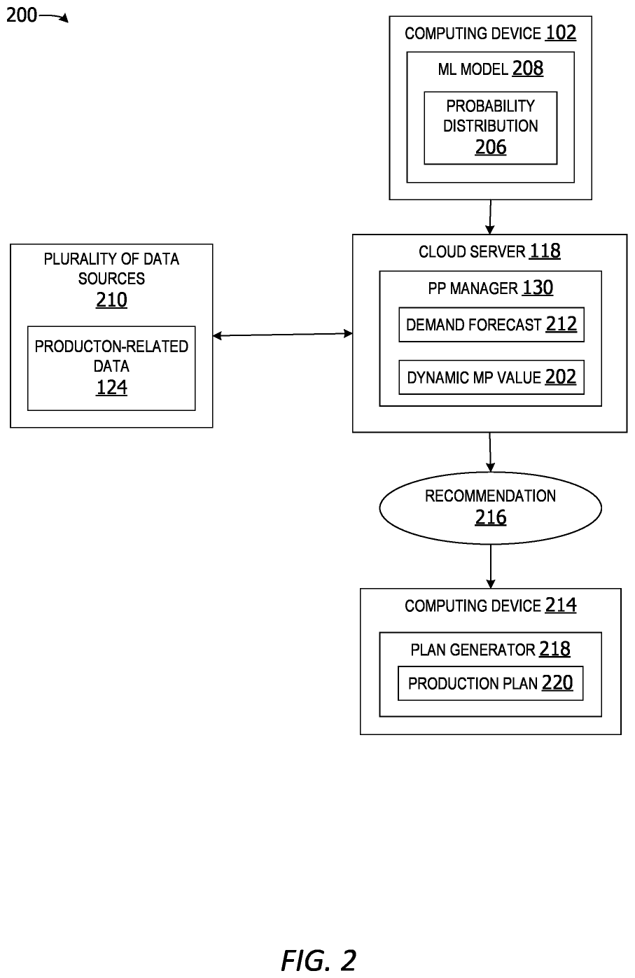

Referring now to FIG. 2, an exemplary block diagram illustrating a system 200 for calculating a dynamic MP value 202 on an item-store-date level is shown. The dynamic MP value 202 is a value for minimum presentation, such as, but not limited to, the dynamic MP value 142 in FIG. 1. The PP manager 130 is hosted on a cloud server 118, in this example. However, in other examples, the PP manager 130 is implemented on a computing device, such as the computing device 102.

In some examples, the PP manager 130 obtains a demand probability distribution 206 generated by a ML model 208. The ML model 208 is a deep learning model that includes pattern recognition, modeling, or other machine learning algorithms to analyze production-related data 124 and other data obtained from a plurality of data sources 210. The production-related data 124 is data associated with production of fresh items. The production-related data 124 includes item attribute data, dynamic data, and historical data. The historical data includes historical minimum presentation numbers, historical fresh items out-of-stock (underproduction), historical throws data (overproduction), etc. The plurality of data sources 210 includes one or more databases, data stores, online data sources, news feeds, news wires, or any other sources of information.

In this example, the ML model 208 is hosted on a computing device 102. However, in other examples, the ML model 208 is hosted on a cloud server, such as the cloud server 118 in FIG. 1 and FIG. 2.

The PP manager 130, in this example, is hosted on the cloud server 118. The PP manager 130 generates a demand forecast 212, including a predicted demand for a fresh item on a given date and/or time-period on the given date. The demand forecast is generated based on data obtained in the probability distribution 206 associated with the fresh item.

The demand forecast 212 optionally includes a predicted demand for one or more segments within the selected date, such as a morning demand prediction, an afternoon demand prediction, and an evening demand prediction. In another example, the demand forecast includes a predicted demand for a first half of a day and a second predicted demand for the second half of the day.

In this example, the PP manager 130 generates a production plan recommendation 216. The recommendation 216 includes the dynamic MP value 202. In other examples, the recommendation 216 includes both the predicted demand and the dynamic MP value 202. The recommendation 216 in some examples is output directly to a user. In other examples, the recommendation is used by a plan generator to create a production plan for one or more fresh items.

In some examples, a plan generator 218 generates a production plan 220 based on the demand forecast 212 and the dynamic MP value 202 In this example, the production plan generator 218 is hosted on a computing device 214 separate from the PP manager on the cloud server 118. However, in other examples, the production plan generator 218 is implemented on the same computing device with the PP manager 130, such as the computing device 102 in FIG. 1. In other examples, the plan generator 218 is implemented on the cloud server 118 with the PP manager. The production plan 220 includes a number of instances of the fresh item sufficient to satisfy the demand forecast 212 and the dynamic MP value 202.

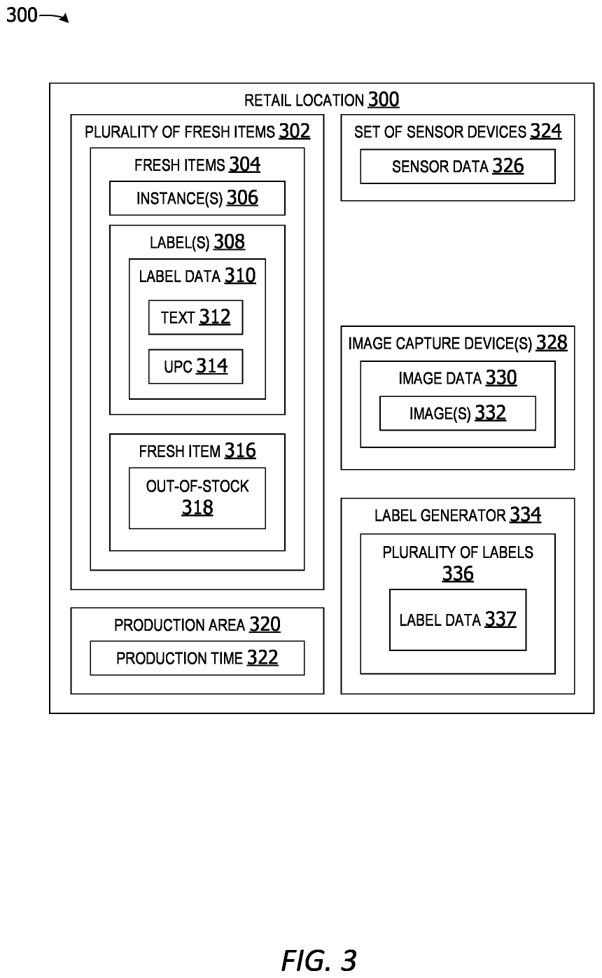

Referring now to FIG. 3, an exemplary block diagram illustrating a retail location 300 associated with fresh items having a safety stock based on MP values calculated at an item-store level is depicted. The retail location is an exemplary environment in which fresh items are produced, prepared, or otherwise obtained for display and/or sale to customers in accordance with the minimum presentation value.

In this example, the retail location 300 includes a plurality of fresh items 302 including at least one fresh item 304. There are one or more instance(s) 306 of the fresh item 304. The plurality of items 302 includes one or more label(s) 308 associated with each item in the plurality of items 302. Each label includes label data 310 having text 312 and/or a universal product code (UPC) 314. In some examples, a sensor device in the set of sensor devices 324 scans a label to obtain label data 310 from a label on a fresh item. In other examples, one or more of the image capture device(s) 328 captures one or more image(s) 332 of a label or portion of the label. The label data 310 associated with a label is obtained from the image of the label.

Instances of the fresh item(s) are produced in one or more areas, such as a production area 320 at the retail location 300. In one example, bread is baked in a production area, such as a bakery. In another example, ground beef is produced in a production area, such as a meat department. Instances of fresh items are produced at a production time 322 each day. In some examples, the production time 322 is at a beginning of each day. In other examples, fresh items are produced twice a day. In other examples, fresh items are produced three times a day.

If a fresh item 316 is underproduced, the item may become out-of-stock 318 before additional instances of the item are produced at the next production time. If overproduction occurs, one or more instances of the item become carry-over to the next day.

In some examples, the retail location 300 includes a set of one or more sensor devices 324 generating sensor data 326 associated with the plurality of items 302. The sensor data 326 is analyzed to update the inventory of fresh items on-hand during the day. The system uses the sensor data to update the dynamic MP value and/or update the recommendation. The updated recommendation is used to recommend additional production of fresh items at a second production time during the day. This prevents item outs.

In other examples, the retail location 300 includes one or more image capture device(s) 328 generating image data 330 associated with the plurality of fresh items 302. The image data 330 includes one or more image(s) 332 of the instance(s) 306 of the fresh items. The image data is used to update inventory information associated with the plurality of fresh items in real-time. The image data 330 is analyzed by the PP manager to update the dynamic MP value and/or update the recommendation in real-time to reflect changing availability of fresh items and/or recommend additional production of fresh items during the current day or increase the recommended number of instances of the fresh items produced on the next day.

In still other examples, the retail location 300 optionally includes a label generator 334. The label generator 334 generates a plurality of label 336 for a plurality of items. The plurality of labels 336 includes labels for fresh items, as well as labels for items which may not be classified as fresh items. One or more of the labels printed by the label generator 334 are placed on instances of the fresh items as the fresh item instances are produced in one or more production area(s) of the retail facility. As each label is printed, the label generator updates inventory associated with the fresh items. The label data 137 generated as the label generator 334 prints the plurality of labels 336, including the number of labels printed for instances of each fresh item, is used to verify the recommended number of instances of the fresh items are produced on the selected date and/or during a given time period on the selected date. The label data 137 may also be used to update the recommendation and/or the dynamic MP value for a fresh item.

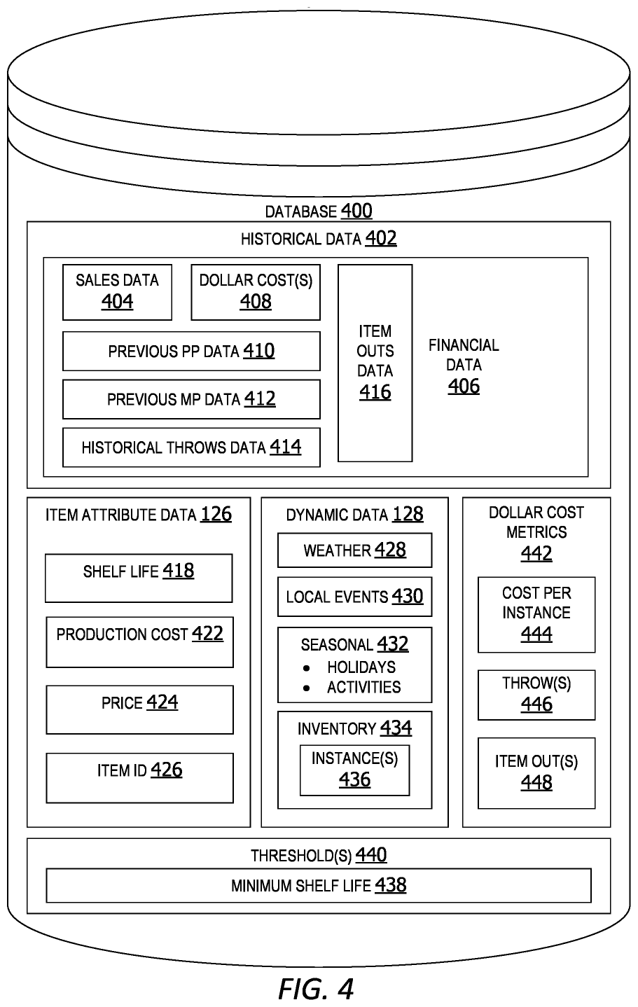

FIG. 4 is an exemplary block diagram illustrating a database 400 storing data used in calculating dynamic MP values. The database 400 is stored on a device for storing data, such as, but not limited to, the data storage device 122 in FIG. 1. The database in other examples is a database in the plurality of data sources 210 in FIG. 2.

In some examples, the database 400 includes production-related data, such as historical data 402. The historical data includes historical financial data 406, such as historical sales data 404 and/or historical dollar cost(s) 408 associated with producing an instance of a fresh item. The historical data in other examples optionally also includes previous production plan data 410, previous minimum presentation data 412 associated with previous MP values for fresh items in the past, historical throws data 414 associated with fresh items that went unsold prior to expiration of the shelf life of the item, and/or item outs data 416 associated with fresh items that went out-of-stock due to underproduction in the past.

The database 400 in other examples stores item attribute data 126. The item attribute data 126 is data associated with a fresh item, such as, but not limited to, shelf life 418, price 424, item ID 426, production cost 422, and/or other attributes of each item. The shelf life 418 is a number of days the item remains fresh or number of days the item is available for purchase before the item becomes classified as a “throw” due to exceeding the shelf life 418. The shelf life 418 may also be referred to as a sell-by-date. The sale price 424 may vary from day to day, depending on varying costs of ingredients, sales, or other promotional events.

The item attribute data 126 optionally also includes a production cost 422 in dollars or other monetary units. The production cost is the cost associated with producing one instance of the item. For example, the production cost for a pie is the costs associated with baking the pie at the retail location. The cost includes the cost of ingredients, employee time spent preparing the pie, energy consumed during baking, or any other expenses associated with preparing the pie.

Dynamic data 128 is data associated with an item and/or the retail location. The dynamic data 128 optionally includes weather 428, local events 430, seasonal 432 and/or current inventory 434. The weather 428 may impact production of items. For example, if the weather is cold, demand for warm or hot items may increase. Likewise, if there is a blizzard or other extreme weather conditions which makes travel difficult, demand for fresh items may temporarily decrease until weather conditions improve.

Local events 430 includes local celebrations, sporting events, etc. For example, a local election, carnival, county fair or band performance may influence demand for certain fresh items. Seasonal 432 refers to holidays and seasonal activities. For example, the Thanksgiving holiday in November may increase demand for fresh bread and fresh pies.

Inventory 434 includes the current number of instance(s) 436 of fresh items and/or updates to the inventory as items are sold, produced, or removed from inventory. The updates may influence production and/or demand for fresh items. For example, production of a fresh item may be hindered if there is a shortage in inventory of one or more ingredients required to produce the fresh item.

Threshold(s) 440 includes one or more threshold values used for generating the predicted demand and/or the dynamic MP value. In some examples, the threshold(s) 440 includes a minimum shelf life 438. The minimum shelf life is a threshold minimum shelf life value used to determine monetary loss associated with overproduction or underproduction of a fresh item. The shorter the shelf life for an item, the greater the monetary loss associated with overproduction. Therefore, if an item has a shelf life that is lower than the minimum shelf life, a penalty is applied to the item to balance the greater monetary loss associated with items that have a short shelf life. In some examples, the minimum shelf life is one day. In another example, the minimum threshold shelf life is two days.

In still other examples, a first threshold shelf life of one day is associated with a first penalty, which is greatest penalty (highest penalty) leveraged against fresh items having a very short shelf life. The penalty is assessed against overproduction. Thus, an item with a very short shelf life is associated with the highest penalty losses associated with producing too many instances of the item. A fresh item with a slightly longer shelf life, such as a shelf life that is greater than or equal to a second threshold shelf life of two days, is associated with a second penalty. The second penalty is less than the first penalty but greater than a third penalty. A fresh item having a shelf life that is greater than or equal to a third threshold shelf life of three days is associated with a third penalty. The third penalty is less than the second penalty but greater than a fourth penalty associated with a shelf life of four days, etc. The first penalty is the greatest penalty due to the single day shelf life rending the item unsuitable for carry-over to the next day. The second penalty is less than the first penalty but greater than the third penalty as the item can carry over for at least one additional day after the day on which the item is produced or prepared. The third penalty is less than the second penalty and greater than the fourth penalty, etc.

In other words, an item having the highest penalty is least suitable for carryover. For example, an item with a shelf life of one day or two days is more likely to become a “throw” if too many instances of the item are produced. Therefore, a greater penalty is leveraged for determining losses due to overproduction of the item. An item with a longer shelf life is least likely to become a “throw” and therefore overproduction is associated with fewer losses. Thus, the system leverages a smaller penalty or no additional penalty for calculating losses due to overproduction of the longer shelf-life item.

The dollar cost metrics 442 are metrics used to measure loss associated with overproduction and underproduction of a given fresh item valued in monetary terms such as dollar losses, instead of as units or instances of the fresh item. The dollar cost metrics 442 are used to determine a cost per instance 444 of each instance (unit) of the fresh item in dollars. The throw(s) 446 indicates the dollar cost associated with each instance of a fresh item that fails to sell prior to the sell-by-date due to overproduction. The item out(s) 448 is a dollar cost associated with lost sales due to underproduction. The item out(s) 448 reflects not only the value of the lost sale (sale price) but also the value of lost customer goodwill and potential loss of customers due to lack of inventory.

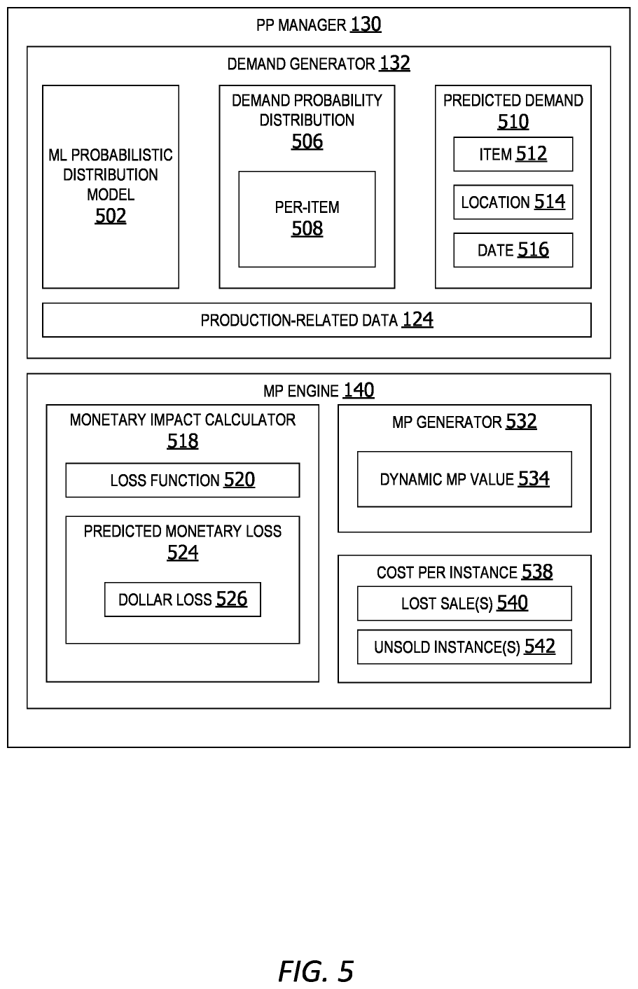

Turning now to FIG. 5, an exemplary block diagram illustrating a production plan (PP) manager 130 for generating dynamic MP values is shown. A demand generator 132 includes a ML probabilistic distribution model 502. The ML probabilistic distribution model 502 is a deep learning ML model, such as, but not limited to, the ML model 208 in FIG. 2.

The ML probabilistic distribution model 502 generates a demand probability distribution 506 including a per-item 508 distribution of possible demand values and probabilities associated with those predicted demand values using production-related data 124, including historical data and dynamic data. The demand probability distribution 506 is a probability distribution, such as, but not limited to, the probability distribution 206 in FIG. 2. A predicted demand 510 for the selected fresh item is identified based on the demand probability distribution 506. In some examples, the predicted demand 510 is the mean demand in the demand probability distribution. In other examples, the predicted demand is the demand value having the highest probability associated with it. The predicted demand is a prediction of demand for a selected fresh item 512, at a selected retail location 514, on a selected date 516. Thus, the demand is generated on an item-store-date level.

The MP engine 140 in some examples, includes a monetary impact calculator 518 including a unique loss function 520 used to calculate monetary level impact of underproduction and underproduction. The monetary level impact includes predicted monetary loss 524 for underproduction and a predicted monetary loss for overproduction. The monetary loss in this example is a dollar loss 526. Thus, the loss due to overproduction is expressed in a dollar value. Likewise, losses due to underproduction are likewise expressed in a dollar value. However, the examples are not limited to dollar cost metrics. In other examples, the monetary losses are expressed in other monetary units, such as cryptocurrency units, euros, pounds, or any other monetary units.

An MP generator 532, in some examples, generates the dynamic MP value 534, including a number of instances of a fresh item to be produced on the selected data in excess of the number of instances of the fresh item associated with the predicted demand 510. The dynamic MP value is generated based on the production cost per instance 538 of the fresh item. The production cost per instance 538 is obtained from item attribute data. The cost per instance of the fresh item includes the costs associated with lost sale(s) 540 and/or costs associated with unsold instance(s) 542, which may be referred to as throws.

In some examples, the monetary impact calculator 518 uses item attribute data and/or dynamic data with the production-related data to generate the predicted demand and/or the dynamic MP value. In other examples, the MP engine 140 includes a deep learning model using pattern recognition and ML algorithms to generate predicted numbers of instances of a fresh item for safety stock in excess of predicted demand such that monetary loss is minimized while optimizing availability of fresh stock for purchase by customers.

The recommendation, in some examples, includes a number of instances of a fresh item sufficient to satisfy the predicted demand for the fresh item on a selected date. The predicted demand is a quantity of instances (units) of the fresh item to meet the expected demand for the selected date without any extra left over. In other words, the predicted demand is a number of fresh items to meet customer demand predicted for the day without exceeding customer demand or falling below customer demand. As it is not possible to know actual demand for a given day in advance, the predicted demand is generated using ML to predict likely demand on the given date.

The dynamic MP value is a number of instances of the fresh item predicted to create a safety stock of extra instances of the fresh item in excess of demand to ensure no item outs occur. The safety stock includes an expected carry-over. The expected carry-over refers to the expectation that most if not all the instances of the fresh items produced in excess of the predicted demand will remain unsold and carry-over to the next day. The carry-over provides instances of the fresh item available for sale when the retail store opens the next day, such that customers can purchase the fresh item before new instances of the fresh item are produced for the day. In other words, prior to any instances of the fresh item being produced by personnel of the retail location on a given day, the carry-over supplies instances of the fresh item for purchase by customers. In this manner, as soon as the retail location opens in the morning, instances of fresh items carried over from the previous day are available to customers while store personnel are busy producing new fresh instances of the fresh items.

In these examples, the predicted demand and the dynamic MP value are produced at the item-store-date level. In other words, the dynamic MP value and the predicted demand are customized based on the specific fresh item, a specific store location (retail location) and a selected date (calendar date/day of the week). This enables the predicted demand and MP value to be dynamically customized each day based on changing events and expectations. The dynamic MP value enables provision of sufficient safety stock within brick-and-mortar stores on a daily basis while minimizing system resource usage consumed in creation of the MP values and production plans.

FIG. 6 is an exemplary flow chart illustrating operation of the computing device to dynamically update a PP recommendation based on real-time inventory updates. The process shown in FIG. 6 is performed by a PP manager component, executing on a computing device, such as the computing device 102 or the user device 116 in FIG. 1.

The process begins by generating a dynamic MP value for a selected fresh item at a selected retail location on a selected date based on item attribute data, historical data, and dollar loss metrics at 602. The PP manager creates a PP recommendation including the dynamic MP value at 604. The PP recommendation includes a recommended number of instances of the selected fresh item to be prepared/produced for safety stock on the selected date. A determination is made whether an update is received at 606. The update is an update in dynamic data regarding available inventory of fresh items and/or an update of dynamic data associated with the retail location. The update is actively obtained or requested (pulled) from one or more sources of dynamic data in some examples. In other examples, the update is passively sent (pushed) at regular intervals or at a predetermined time each day. The dynamic data is obtained from one or more data stores, such as the data storage device.

If an update is received, the PP manager identifies fresh item inventory for the selected fresh item at the selected retail facility at 608. The item inventory refers to the number of instances of the fresh item currently in stock (available for purchase). A determination is made whether the current inventory is enough to meet any changes in demand (updated demand) indicated by the update at 610. An update to the predicted demand may occur if sales of the fresh item are higher than expected, fewer instances of the fresh item were actually produced than was recommended for the day, etc.

If the current inventory is not enough (insufficient), the dynamic MP value is updated at 612. The PP manager creates an updated PP recommendation at 614. The updated PP recommendation can include an updated recommendation for additional production at the next production time on the current date and/or updated recommendation for additional production at the next production time on the following day. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to generate a dynamic MP value using item attribute data and monetary loss function. The process shown in FIG. 7 is performed by a PP manager component, executing on a computing device, such as the computing device 102 or the user device 116 in FIG. 1.

The process begins by obtaining predicted demand for a given fresh item at a selected retail location at 702. The predicted demand is obtained from a demand generator, such as, but not limited to, the demand generator 132 in FIG. 1. The PP manager obtains production-related data, including item attribute data, for the fresh item at 704. The item attribute data and other relevant data is obtained from a data source, such as, but not limited to, the data storage device 122 in FIG. 1, the plurality of data sources 210 in FIG. 2 and/or the database 400 in FIG. 4. The other related data includes historical production data, threshold data, dynamic data, and any other data relevant to determining monetary loss.

The PP manager calculates monetary loss associated with the fresh item at 706 based on the item attribute data, predicted demand and any other relevant data.

The shelf life of the fresh item is identified at 708. The shelf life is found in the item attribute data in some examples. A determination is made whether the shelf life is below a threshold minimum shelf life at 710. If yes, a penalty is applied to the fresh item having the shelf life below the threshold at 712. The penalty is a penalty for overproduction, which is applied to items with a short shelf life to more accurately determine the monetary loss associated with item throws associated with items having a higher likelihood of becoming throws due to their shorter shelf life. The penalty is used to weight monetary loss determinations and/or determining optimal MP for the fresh items having a shorter shelf life. A dynamic minimum presentation value is generated at 714. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an exemplary flow chart illustrating operation of the computing device to generate a dynamic PP recommendation. The process shown in FIG. 8 is performed by a PP manager component, executing on a computing device, such as the computing device 102 or the user device 116 in FIG. 1.

The process begins by calculating monetary level impact of overproduction and underproduction of a fresh item at 802. The PP manager generates a dynamic MP value based on the calculated monetary level impact of overproduction and underproduction at 804. The PP manager creates a production plan recommendation based on the predicted demand and the dynamic MP value at 806. The production plan recommendation includes the predicted demand and the dynamic MP value. The recommendation is output to a user interface device at 808. The user interface device is a device such as, but not limited to, the user interface device 110 and/or the user interface device 120 in FIG. 1. A determination is made whether there is a next fresh item which needs a production plan recommendation for a future date at 810. In some examples, a next fresh item which needs a production plan is a next item classified as a fresh item which does not yet have a production plan for a current day and/or the following day. This determination can be made by checking for existence of a production plan for each fresh item in inventory as recorded in a database or other inventory records in a data store. If yes, the process executes operations 802 through 808 until no additional fresh item production plan recommendations are needed at 810. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

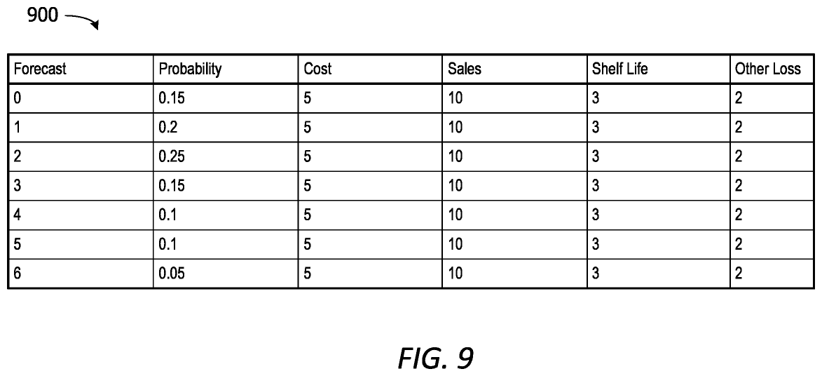

FIG. 9 is an exemplary table 900 showing input data for generating dynamic MP value. The table 900 includes forecast probabilities associated with a fresh item.

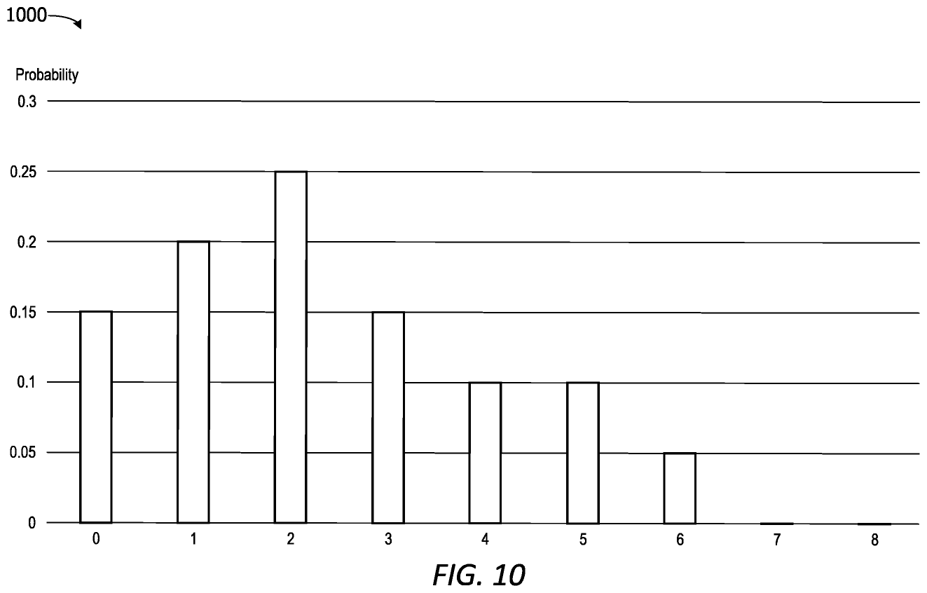

FIG. 10 is an exemplary bar graph 1000 representing a probability distribution for a fresh item. With the probability distribution for the demand, the PP manager can simulate the probability mass function for each item/club/date. The system derives the mean demand of this distribution, which is required for calculating optimized minimum presentation later. The equation for “optimizedMinPres” above is applied on this distribution to obtain the global optimal demand upon the objective function.

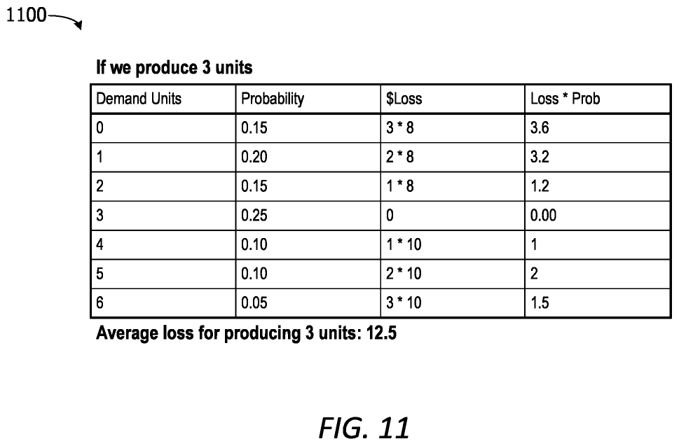

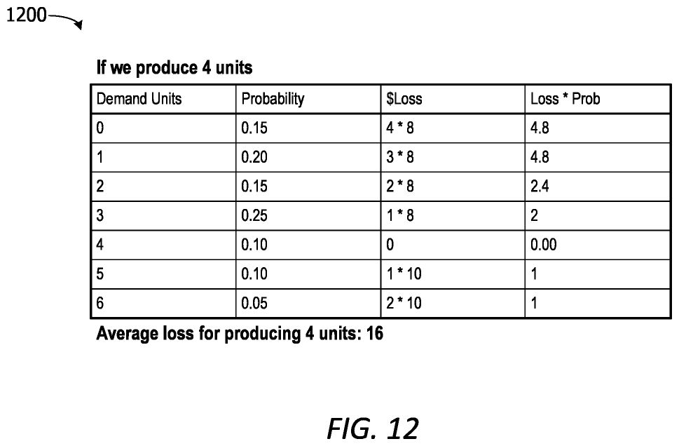

FIG. 11 is an exemplary table 1100 representing calculated values where three instances (units) of a fresh item are produced. FIG. 12 is an exemplary table 1200 representing calculated values where four instances (units) of the fresh item are produced. In this case, three instances of the fresh item balance all risks and opportunities better than four instances of the fresh Item, which provides us the optimal production quantity.

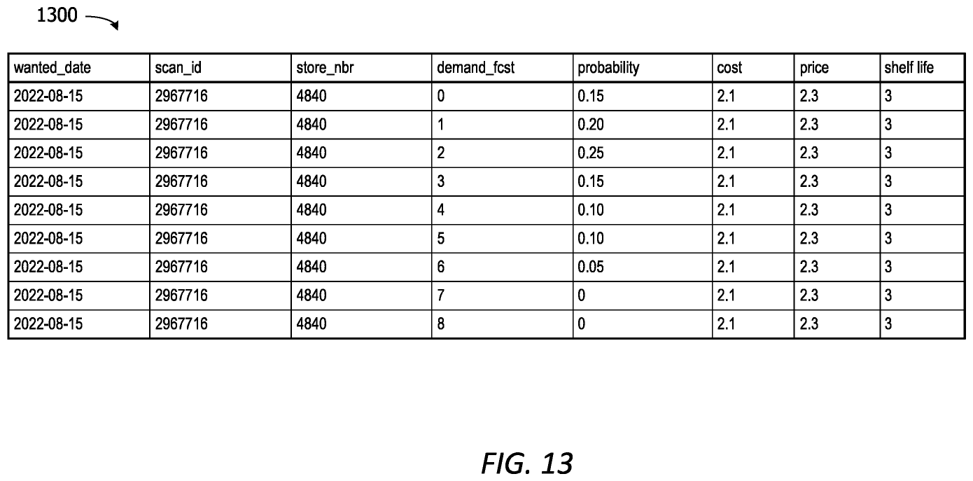

FIG. 13 is an exemplary table 1300 representing exemplary input and output associated with the production plan manager. The ‘Wanted_date’ is the selected date for which the system is generating a forecast. The ‘Scan_id’ is the unique indicator for a fresh item, such as an item ID. The ‘Store_nbr’ is the unique indicator of the retail location, such as a store ID. Cost is the dollar cost for a unit of the fresh item, price is the dollar sales price for a unit and shelf life is the days of shelf life. With demand_fcst and probability, the system is able to simulate the probability mass function for each item/club/date.

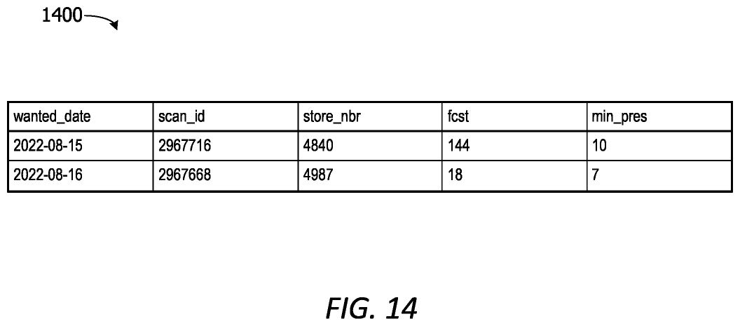

FIG. 14 is an exemplary table 1400 representing exemplary output generated by the PP manager. The system provides two point estimator, the predicted demand, and the minimum presentation (min_pres) forecast in item/club/date granularity. The Wanted_date is the selected date for the forecast. The Scan_id is the unique indicator fresh item. The store_nbr is the unique indicator of the store (retail location). The fest is the demand forecast. The min_pres is the minimum presentation recommendation. The system generates a dynamic minimum presentation value that boosts sales and reduces monetary losses from throws due to overproduction.

The system retains and makes inferences for the probabilistic forecast model, and then publishes the probabilistic distribution as an input to the MP manager optimization engine to generate final point estimator. A point estimator is a statistic that is used to estimate the value of unknown parameters of a population, such as the predicted demand and/or the minimum presentation value.

In some examples, the system includes a model-based inventory optimization solution that performs better than heuristic rules-based methods, especially for fresh items. Instead of keeping daily minimum presentation close to next day demand, the PP manager provides a dynamic solution that can reduce 20% of waste and maintain a service level of more than 90%. This is particularly effective in reducing waste for low-shelf-life fresh items, such as croissants, which are more likely to become waste when overproduced. Additionally, the PP manager includes an ML model that is intelligent enough to adjust to different demand patterns for the same item in different regions, markets, and stores.

### Additional Examples

In some examples, the PP manager addresses the problem of overproduction and underproduction in fresh item production at retail locations. The optimized minimum presentation generated by the system allows improved control of the amount of production desired in the excess of the expected demand, ensuring that a safety stock for fresh items that have a short shelf life is maintained to fulfill customer demand. The system generates a deep learning probabilistic forecast which reduces projected losses due to overproduction and underproduction. In one example, the system reduced losses by a projected $8M per year from throws while boosting the sales as the same fresh time.

In some examples, the MP engine determines the optimal safety stock per club/item/date, considering the loss from both overproduction and underproduction. It is based on a reformatted “newsvendor” problem and establishes a unique loss function for the optimization engine for MP. The system utilizes a unique loss function in a deep learning framework by integrating comprehensive fresh item attributes, including item shelf life, dollar sales, dollar throws, production plan etc.

In other examples, the system includes historical tabular data obtained from various internal and/or external sources of raw data. The granularity is either item level or item/club level. The in-store sales history table contains a full set of in-store sales for each item/store/date. The item attributes table provides comprehensive item attributes information including fresh items shelf life (shelf_life), product size, etc. A fresh production plan table contains daily actual planning for fresh items, for example carryover, user adjustment, home office growth goal, etc. A financial report table provides dollar sales, dollar throws, and unit throws information utilized by the PP manager to generate predicted demand and/or the dynamic MP value.

Other examples provide a system for predicting a minimum presentation quantity of perishable items/products to be produced/available on a given day (i.e., the number of products needed to avoid losses due to forecasts that are too high or too low). The system takes input from a forecast model which provides the probability of a particular quantity demand using machine learning. The model analyses various quantities, probabilities, and costs for over or under-supply to provide the optimized minimum presentation quantity. The system generates a customized loss with the objective that minimizes the loss from both under-forecast and over-forecast. The system outputs the forecast and the minimum presentation quantity. The system takes feedback by recording the quantity made each day and a deviation from the model's recommendation. The system accounts for a carryover of fresh items from the previous day, a reduction in value for the carried-over items, and/or another feature.

Alternatively, or in addition to the other examples described herein, examples include any combination of the following:
wherein the predicted monetary loss includes dollar cost value associated with sale price of the fresh item, production costs associated with producing the fresh item, reduced value due to loss of freshness for fresh item single day carryover, and dollar cost value of membership loss due to insufficient fresh item inventory;
wherein the dynamic data comprises weather-related data, local events data, and seasonal data, wherein seasonal data comprises data associated with holidays and seasonal activities;
obtain scan data associated with instances of the fresh item at the retail location on the selected date after a first production period, the scan data indicating a number of instances of the fresh item remaining available for purchase;
determining a number of instances of the fresh item available for purchase during a remainder of a current day based on the scan data;
generate an updated dynamic MP value in real-time on the selected date reflecting real-time inventory levels and expected demand for the remainder of the current day;
generate an updated production plan recommendation including the updated dynamic MP value for implementation during a second production period at the retail location;
wherein a number of instances of the fresh item indicated in the updated dynamic MP value is produced during the second production period;
obtain label data associated with instances of the fresh item at the retail location on the selected date after the first production period;
wherein label data comprises data associated with labels placed on instances of fresh items produced during the first production period;
determine a number of instances of the fresh item available for purchase during a remainder of a current day based on the label data;
generate a production plan for the retail location, the production plan comprising production of a recommended number of instances of the fresh item on the selected date;
the recommended number of instances of the fresh item comprising the number of instances of the fresh item sufficient to satisfy the predicted demand and the number of instances of the fresh item sufficient to satisfy the dynamic MP value;
wherein the production plan is presented to a user via a user interface device;
translate a predicted number of instances of the fresh item remaining unsold at the end of the selected date into a dollar level impact, wherein the dollar level impact reflects dollar loss due to costs associated with the unsold instances of the fresh item;
translate a predicted number of instances of the fresh item associated with potential lost sales from underproduction into the dollar level impact;
wherein the dollar level impact reflects dollar loss due to lost sales occurring as a result of an out-of-stock status of the fresh item;
apply a freshness penalty associated with overproduction of the fresh item, the freshness penalty is inversely related to shelf life of the fresh item;
wherein a first freshness penalty is applied against a first fresh item having a first shelf life which is shorter than a threshold minimum shelf life;
wherein a second freshness penalty is applied against a second fresh item having a second shelf life which is greater than the threshold minimum shelf life;
obtaining a predicted demand for a fresh item at a retail location on a selected date from a demand probability distribution;
calculating a monetary level impact of overproduction of the fresh item and the monetary level impact of underproduction of the fresh item using item attribute data for the fresh item;
wherein the item attribute data comprises shelf life of the fresh item, production cost per instance of the item, wherein the monetary level impact comprises a predicted monetary loss form lost sales and predicted monetary loss from unsold instances of the fresh item;
generating a dynamic minimum presentation (MP) value customized at an item level using historical production-related data for the fresh item and the retail location and the calculated monetary level impact of overproduction and underproduction;
wherein the dynamic MP value includes a recommended number of instances of the fresh item to be produced at the retail location in excess of the predicted demand for the fresh item on the selected date;
creating a production plan recommendation including the predicted demand and the dynamic MP value;
wherein the dynamic MP value optimizes safety stock in excess of the predicted demand for the fresh item at the retail location on the selected date while minimizing monetary loss associated with the overproduction and the underproduction of the fresh item;
wherein a number of instances of the fresh item identified in the predicted demand and the dynamic MP value are produced on the selected date;
obtaining image data associated with instances of the fresh item at the retail location on the selected date after the first production period, the image data generated by a plurality of imaging devices;
analyzing the image data to determine a number of instances of the fresh item available for purchase during a remainder of a current day based on the image data;
comparing the number of instances of the fresh item available for purchase with the predicted demand and the dynamic MP value;
updating the dynamic MP value in real-time on the selected date to reflect real-time inventory levels and expected demand for the remainder of the current day;
generating an updated production plan recommendation including the updated dynamic MP value for implementation during a second production period at the retail location, wherein a number of instances of the fresh item indicated in the updated dynamic MP value is produced during the second production period;
wherein a number of instances of the fresh item are produced during a first production period at the retail location;
obtaining label data associated with instances of the fresh item at the retail location on the selected date after the first production period;
wherein label data comprises data associated with labels placed on instances of fresh items produced during the first production period;
analyzing the label data;
determining a number of instances of the fresh item available for purchase during a remainder of a current day using the label data;
comparing the number of instances of the fresh item available for purchase with the predicted demand and the dynamic MP value;
updating the dynamic MP value in real-time to reflect real-time inventory levels and expected consumption levels for the remainder of the current day;
generating an updated production plan recommendation including the updated dynamic MP value for implementation during a second production period at the retail location;
wherein a number of instances of the fresh item indicated in the updated dynamic MP value is produced during the second production period;
obtaining scan data associated with instances of the fresh item at the retail location on the selected date after the first production period, the scan data generated by a plurality of sensor devices;
analyzing the scan data;
determining a number of instances of the fresh item available for purchase during a remainder of a current day using the scan data;
translating a predicted number of instances of the fresh item remaining unsold at the end of the selected date into a dollar level impact, wherein the dollar level impact reflects dollar loss due to costs associated with the unsold instances of the fresh item;
translating a predicted number of instances of the fresh item associated with potential lost sales from underproduction into the dollar level impact, wherein the dollar level impact reflects dollar loss due to lost sales occurring as a result of an out-of-stock status of the fresh item;
applying a freshness penalty associated with overproduction of the fresh item, the freshness penalty is inversely related to shelf life of the fresh item;
wherein a higher dynamic MP value is assigned to fresh items having a shelf life that is greater than a threshold minimum shelf life;
wherein a lower dynamic MP value is assigned to fresh items having shelf life that is less than the threshold minimum shelf life;
generating a production plan for the retail location, the production plan comprising production of a recommended number of instances of the fresh item on the selected date;
wherein the recommended number of instances of the fresh item comprising the number of instances of the fresh item sufficient to satisfy the predicted demand and the number of instances of the fresh item sufficient to satisfy the dynamic MP value;
presenting the production plan to a user via a user interface device;
adding a number of instances of the fresh item sufficient to meet the predicted demand with a number of instances of the fresh item in the dynamic MP value to form a recommended production number of instances of the fresh item for production on the selected date;
generating a production plan including a recommended production number for the fresh item at the retail location on the selected date, wherein the production plan is customized at an item-store-date level.
generate, via a machine learning (ML) probabilistic distribution model, a demand probability distribution for a fresh item associated with a selected retail location using production-related data, including item attribute data for the fresh item;
identify a predicted demand for the fresh item on a selected date using the generated demand probability distribution and the historical data;
calculate a monetary level impact of overproduction of the fresh item and underproduction of the fresh item using the item attribute data;
generate a dynamic minimum presentation (MP) value for the selected date using dynamic data associated with the retail location and the selected date, the item attribute data, and the predicted monetary loss;
apply a first freshness penalty associated with overproduction to a first fresh item having a shelf life greater than a threshold minimum shelf life;
apply a second freshness penalty to a second fresh item having a shorter shelf life that is less than the threshold minimum shelf life, wherein the freshness penalty is inversely related to shelf life of the fresh item;
translate a predicted number of instances of the fresh item remaining unsold at the end of the selected date into a dollar level impact, wherein the dollar level impact reflects dollar loss due to costs associated with item throws;
translate a predicted number of instances of the fresh item associated with potential lost sales from underproduction into the dollar level impact, wherein the dollar level impact reflects dollar loss due to lost sales occurring as a result of an out-of-stock status of the fresh item; and
wherein the dynamic MP value is customized at an item-store-date level.

At least a portion of the functionality of the various elements in FIG. 1, FIG. 2, FIG. 3, FIG. 4, FIG. 5 and FIG. 6 can be performed by other elements in FIG. 1, FIG. 2, FIG. 3, FIG. 4, FIG. 5 and FIG. 6, or an entity (e.g., processor 106, web service, server, application program, computing device, etc.) not shown in FIG. 1, FIG. 2, FIG. 3, FIG. 4, FIG. 5 and FIG. 6.

In some examples, the operations illustrated in FIG. 7, FIG. 8 and FIG. 9 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of fresh item dynamic minimum presentation prediction; generating a dynamic minimum presentation (MP) value customized at an item level using the item attribute data, the calculated monetary level impact of overproduction and underproduction and historical production-related data associated with the fresh item at a selected retail location; creating a production plan recommendation including the dynamic MP value, wherein a number of instances of the fresh item identified in the predicted demand and the dynamic MP value are produced on the selected date; and presenting the production plan recommendation, including the dynamic MP value, to a recipient via a user interface device.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for fresh item dynamic minimum presentation prediction using dollar cost metrics. For example, the elements illustrated in FIG. 1, FIG. 2, FIG. 3, FIG. 4, FIG. 5 and FIG. 6, such as when encoded to perform the operations illustrated in FIG. 7, FIG. 8, and FIG. 9, constitute exemplary means for obtaining a demand probability distribution for a fresh item associated with a selected retail location; exemplary means for identifying a predicted demand for the fresh item on a selected date using the demand probability distribution; exemplary means for calculating a monetary level impact of overproduction of the fresh item and underproduction of the fresh item using the item attribute data; and exemplary means for generating a dynamic minimum presentation (MP) value customized at an item-store level for the selected date using dynamic data associated with the retail location and the selected date, the item attribute data and the predicted monetary loss.

Other non-limiting examples provide one or more computer storage devices having a first computer-executable instructions stored thereon for providing dynamic minimum presentation values for production plans associated with fresh items. When executed by a computer, the computer performs operations including generating a demand probability distribution for a fresh item associated with a selected retail location using production-related data for the fresh item; identifying a predicted demand for the fresh item on a selected date using the demand probability distribution and the historical data; calculating a monetary level impact of overproduction of the fresh item and underproduction of the fresh item using the item attribute data; and generating a dynamic minimum presentation (MP) value for the selected date using dynamic data associated with the retail location and the selected date, the item attribute data and the predicted monetary loss.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to “B” only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for fresh item dynamic minimum presentation prediction using dollar cost metrics, the system comprising:
a data storage device comprising production-related data for fresh items, the production-related data including item attribute data associated with each fresh item in a plurality of fresh items; and
a computer-readable medium storing a minimum presentation (MP) engine, that is operative upon execution by a processor to:
identify a predicted demand for a fresh item associated with a selected retail location on a selected date using a demand probability distribution for the fresh item;
calculate a monetary level impact of overproduction of the fresh item and underproduction of the fresh item using the item attribute data, wherein the item attribute data comprises a shelf life of the fresh item and a production cost per each instance of the fresh item, wherein the calculated monetary level impact comprises a predicted monetary loss from overproduction and underproduction, the predicted monetary loss from overproduction comprising monetary loss associated with a lost sale due to unavailability of the fresh item, and wherein the monetary loss from underproduction comprises monetary loss associated with an unsold instance of the fresh item; and
calculate a dynamic MP value customized at an item-store level for the selected date using dynamic data associated with the selected retail location and the selected date, the item attribute data, and the predicted monetary loss, wherein the dynamic MP value includes a recommended number of instances of the fresh item to be produced at the selected retail location in excess of the predicted demand for the fresh item on the selected date; and
generate a production plan recommendation based on the predicted demand and the dynamic MP value, wherein the dynamic MP value enables creation of adequate safety stock for the fresh item while minimizing resource usage.

2. The system of claim 1, wherein the predicted monetary loss includes dollar cost value associated with sale price of the fresh item, production costs associated with producing the fresh item, reduced value due to loss of freshness for fresh item single day carryover, and dollar cost value of membership loss due to insufficient fresh item inventory.

3. The system of claim 1, wherein the MP engine is further operative to:
obtain scan data associated with instances of the fresh item at the selected retail location on the selected date after a first production period, the scan data indicating a number of instances of the fresh item remaining available for purchase;
generate an updated dynamic MP value in real-time on the selected date reflecting real-time inventory levels and expected demand for a remainder of a current day based on the scan data; and
generate an updated production plan recommendation including the updated dynamic MP value for implementation during a second production period at the selected retail location, wherein a number of instances of the fresh item indicated in the updated dynamic MP value is produced during the second production period.

4. The system of claim 1, wherein the MP engine is further operative to:
obtain label data associated with instances of the fresh item at the selected retail location on the selected date after a first production period, wherein the label data comprises data associated with labels placed on the instances of the fresh items produced during the first production period;
determine a number of instances of the fresh item available for purchase during a remainder of a current day based on the label data;
generate updated dynamic MP value in real-time to reflect real-time inventory levels and expected demand for the remainder of the current day; and
update the production plan recommendation including the updated dynamic MP value for implementation during a second production period at the selected retail location, wherein the number of instances of the fresh item indicated in the updated dynamic MP value is produced during the second production period.

5. The system of claim 1, wherein the MP engine is further operative to:
present the production plan recommendation to a user via a user interface (UI), wherein the production plan recommendation comprising the number of instances of the fresh item sufficient to satisfy the predicted demand and the number of instances of the fresh item sufficient to satisfy the dynamic MP value.

6. The system of claim 1, wherein the MP engine is further operative to:
translate a predicted number of instances of the fresh item remaining unsold at an end of the selected date into a dollar level impact, wherein the dollar level impact reflects dollar loss due to costs associated with unsold instances of the fresh item; and
translate a predicted number of instances of the fresh item associated with potential lost sales from underproduction into the dollar level impact, wherein the dollar level impact reflects dollar loss due to lost sales occurring as a result of an out-of-stock status of the fresh item.

7. The system of claim 1, wherein the MP engine is further operative to:
apply a freshness penalty associated with overproduction of the fresh item, the freshness penalty is inversely related to shelf life of the fresh item, wherein a first freshness penalty is applied against a first fresh item having a first shelf life which is shorter than a threshold minimum shelf life, and wherein a second freshness penalty is applied against a second fresh item having a second shelf life which is greater than the threshold minimum shelf life.

8. A method for fresh item dynamic minimum presentation prediction using dollar cost metrics, the method comprising:
calculating a monetary level impact of overproduction and underproduction of a fresh item using item attribute data for the fresh item, wherein the item attribute data comprises shelf life of the fresh item, production cost per instance of the fresh item, wherein the monetary level impact comprises a predicted monetary loss from a lost sale and a predicted monetary loss from an unsold instance of the fresh item;
generating a dynamic minimum presentation (MP) value customized at an item level using the item attribute data, the calculated monetary level impact of overproduction and underproduction and historical data associated with the fresh item at a selected retail location, wherein the dynamic MP value includes a recommended number of instances of the fresh item to be produced at the selected retail location in excess of predicted demand for the fresh item on a selected date;
creating a production plan recommendation including the dynamic MP value, wherein a number of instances of the fresh item identified in the predicted demand and the dynamic MP value are produced on the selected date; and
presenting the production plan recommendation, including the dynamic MP value, to a recipient via a user interface device, wherein the dynamic MP value enables creation of safety stock while minimizing resource usage.

9. The method of claim 8, wherein a number of instances of the fresh item are produced during a first production period at the selected retail location, and further comprising:
obtaining image data associated with instances of the fresh item at the selected retail location on the selected date after the first production period, the image data generated by a plurality of imaging devices;
analyzing the image data;
determining a number of instances of the fresh item available for purchase during a remainder of a current day based on the image data;
comparing the number of instances of the fresh item available for purchase with the predicted demand and the dynamic MP value;
updating the dynamic MP value in real-time on the selected date to reflect real-time inventory levels and expected demand for the remainder of the current day; and
generating an updated production plan recommendation including the updated dynamic MP value for implementation during a second production period at the selected retail location, wherein a number of instances of the fresh item indicated in the updated dynamic MP value is produced during the second production period.

10. The method of claim 8, wherein a number of instances of the fresh item are produced during a first production period at the selected retail location, and further comprising:
obtaining label data associated with instances of the fresh item at the selected retail location on the selected date after the first production period, wherein label data comprises data associated with labels placed on the instances of fresh items produced during the first production period;
analyzing the label data;
determining a number of instances of the fresh item available for purchase during a remainder of a current day using the label data;
comparing the number of instances of the fresh item available for purchase with the predicted demand and the dynamic MP value;
updating the dynamic MP value in real-time to reflect real-time inventory levels and expected consumption levels for the remainder of the current day; and
generating an updated production plan recommendation including the updated dynamic MP value for implementation during a second production period at the selected retail location, wherein a number of instances of the fresh item indicated in the updated dynamic MP value is produced during the second production period.

11. The method of claim 8, wherein a number of instances of the fresh item are produced during a first production period at the selected retail location, and further comprising:
obtaining scan data associated with instances of the fresh item at the selected retail location on the selected date after the first production period, the scan data generated by a plurality of sensor devices;
analyzing the scan data;
determining a number of instances of the fresh item available for purchase during a remainder of a current day using the scan data;
comparing the number of instances of the fresh item available for purchase with the predicted demand and the dynamic MP value;
updating the dynamic MP value in real-time on the selected date to reflect real-time inventory levels and expected demand for the remainder of the current day; and
generating an updated production plan recommendation including the updated dynamic MP value for implementation during a second production period at the selected retail location, wherein a number of instances of the fresh item indicated in the updated dynamic MP value is produced during the second production period.

12. The method of claim 8, further comprising:
translating a predicted number of instances of the fresh item remaining unsold at an end of the selected date into a dollar level impact, wherein the dollar level impact reflects dollar loss due to costs associated with the unsold instances of the fresh item; and
translating a predicted number of instances of the fresh item associated with potential lost sales from underproduction into the dollar level impact, wherein the dollar level impact reflects dollar loss due to lost sales occurring as a result of an out-of-stock status of the fresh item.

13. The method of claim 8, further comprising:
applying a freshness penalty associated with overproduction of the fresh item, the freshness penalty is inversely related to the shelf life of the fresh item, wherein a higher dynamic MP value is assigned to fresh items having the shelf life that is greater than a threshold minimum shelf life, and wherein a lower dynamic MP value is assigned to fresh items having the shelf life that is less than the threshold minimum shelf life.

14. The method of claim 8, further comprising:
adding a number of instances of the fresh item sufficient to meet the predicted demand with a number of instances of the fresh item in the dynamic MP value to form a recommended production number of instances of the fresh item for production on the selected date; and
generating a production plan including the recommended production number for the fresh item at the selected retail location on the selected date, wherein the production plan is customized at an item-store-date level.

15. One or more computer storage devices having computer-executable instructions stored thereon, which, upon execution by a computer, cause the computer to perform operations comprising:
generate, via a machine learning (ML) probabilistic distribution model, a demand probability distribution for a fresh item associated with a selected retail location using production-related data, including item attribute data for the fresh item;
identify a predicted demand for the fresh item on a selected date using the demand probability distribution;
calculate a monetary level impact of overproduction of the fresh item and underproduction of the fresh item using the item attribute data, wherein the item attribute data comprises a shelf life of the fresh item and a production cost per each instance of the fresh item, wherein the calculated monetary level impact comprises predicted monetary loss from lost sales and predicted monetary loss from unsold instances of the fresh item;
generate a dynamic minimum presentation (MP) value for the selected date using dynamic data associated with the selected retail location and the selected date, the item attribute data, and the predicted monetary loss, wherein the dynamic MP value includes a recommended number of instances of the fresh item to be produced at the selected retail location in excess of the predicted demand for the fresh item on the selected date; and
create a production plan recommendation using the dynamic MP value,
wherein the dynamic MP value enables provision of sufficient safety stock while minimizing system resource usage.

16. The one or more computer storage devices of claim 15, wherein the operations further comprise:
generate a production plan for the selected retail location based on the production plan recommendation, the production plan comprising production of a recommended number of instances of the fresh item on the selected date, the recommended number of instances of the fresh item comprising the number of instances of the fresh item sufficient to satisfy the predicted demand and the number of instances of the fresh item sufficient to satisfy the dynamic MP value.

17. The one or more computer storage devices of claim 15, wherein the operations further comprise:
apply a first freshness penalty associated with overproduction to a first fresh item having the shelf life greater than a threshold minimum shelf life; and
apply a second freshness penalty to a second fresh item having a shorter shelf life that is less than the threshold minimum shelf life, wherein the freshness penalty is inversely related to the shelf life of the fresh item.

18. The one or more computer storage devices of claim 15, wherein the operations further comprise:
translate a predicted number of instances of the fresh item remaining unsold at an end of the selected date into a dollar level impact, wherein the dollar level impact reflects dollar loss due to costs associated with the unsold instances of the fresh item.

19. The one or more computer storage devices of claim 15, wherein the operations further comprise:
translate a predicted number of instances of the fresh item associated with potential lost sales from underproduction into dollar level impact, wherein the dollar level impact reflects dollar loss due to lost sales occurring as a result of an out-of-stock status of the fresh item.

20. The one or more computer storage devices of claim 15, wherein the dynamic MP value is customized at an item-store-date level.
